(19) United States
(12) Patent Application Publication
(10) Pub. No.: US 2022/0063354 A1
(43) Pub. Date: Mar. 3, 2022

(54) WHEEL-MOUNTED RUN-FLAT TIRE INSERT AND ASSOCIATED METHODS

(71) Applicant: William Perciballi, Phoenix, AZ (US)

(72) Inventor: William Perciballi, Phoenix, AZ (US)

(21) Appl. No.: 17/002,104

(22) Filed: Aug. 25, 2020

(51) Int. Cl. B60C 17/06; B60C 17/04

(52) U.S. Cl. CPC B60C 17/06; B60C 17/041

(57) ABSTRACT

The run-flat tire insert is for use with a wheel having flanges, and a corresponding pneumatic tire having sidewall tire beads with a bead lock edge. The run-flat tire insert includes a deformable annular insert member having a generally U-shaped cross-section with a band portion between opposing leg portions extending radially inward towards the wheel. The deformable annular insert member is made of a fiber-reinforced composite material. The deformable annular insert member is configured as a spring that deflects under load and transmits vertical load forces on the band portion to lateral forces at ends of the opposing leg portions adjacent the bead lock edges of the pneumatic tire against the wheel flanges.

### FIELD OF THE INVENTION

The present invention relates in general to the field of tires, and in particular to “run-flat” tubeless, pneumatic tires that use a wheel-mounted interior insert to provide run-flat capability and associated methods.

### BACKGROUND OF THE INVENTION

In general, run flat capability for pneumatic tires use either (a) a rigid wheel-mounted interior insert, or (b) stiffened sidewall systems applied to the tire (or stiffened sidewall tire built for run flat operations).

Stiffened sidewall systems offer ease of installation and weight savings benefits that appeal to commercial automotive applications. However, stiffened sidewall systems are not suitable for heavy duty or military use because: (a) they interfere with intentional low tire pressure operations that are required for traction and mobility in various operations (e.g. the stiffened sidewall prevents the tire from flattening to increase tire footprint and traction); and (b) they lack the structural rigidity to support vehicle loads and run flat drive distance.

Heavy duty and military tires may use wheel-mounted internal run-flat inserts that serve as a second, smaller diameter tire that supports the vehicle during flat tire operation. The military market is a major market for run flat tire inserts because tire damage reduces vehicle mobility and increases vulnerability as a stationary or slow-moving vehicle is easier to target. Tires can be shot out or damaged by mine/IED blasts that hamper vehicle operations. Accordingly, in these circumstances, for example, run-flat tire inserts are used to overcome the flat tire problem and provide mobility for a damaged or flat tire.

FIG. 1 is a schematic exploded view illustrating a segmented rubber insert 10 according to a conventional approach, for example, as provided by the Hutchinson Company of Trenton, N.J. Multiple insert segments (e.g., 2-3) are used. The wheel assembly 12 includes a barrel 14 and an inboard flange 16 and outboard flange 18. FIG. 2 is a schematic exploded view illustrating a single donut rubber insert 20 according to a conventional approach, and FIG. 3 is a cross-sectional view of the single donut rubber insert 20 of FIG. 2. These inserts can also be a molded plastic or composite donut that is faced with rubber.

Such current run-flat tire inserts 10 and 20 are made from, or use, significant amounts of rubber, a non-structural material. The drawbacks of solid rubber and rubber coated/rimmed run flat inserts include being too heavy, exhibiting generally inferior structural properties and having especially low strength, creating too much friction between the insert and the tire (resulting in tire fires), and being poor thermal conductors (e.g., they do not conduct frictional heating away for tire/run-flat insert interface resulting in tire fires).

Indeed, adding typical run-flat inserts substantially increases the weight of the wheel assembly, and in-turn, the vehicle and often nearly doubles the weight of the tire and wheel assembly 12. Heavy duty and military vehicles commonly use four, six, or eight wheels so weight increases are magnified. If the inserts are too heavy, they can interfere with/prevent amphibious operations, and if this happens, the run flat inserts are removed altogether, reducing mobility and survivability. Also, with the current approaches, a flat tire rides on a rubber run-flat insert and the rubber-to-rubber friction creates heat which may result in tire fires. This friction problem is currently addressed by limiting the driving range on flat tires to distances that do not result in fires.

The current run-flat inserts are constructed from low-strength materials, the vibration and structural loads resulting from supporting the vehicle weight during run-flat operations often exceed the strength and durability of the current run-flat inserts. The combination of heat build-up and structural loading softens the rubber until the rubber can no longer support the weight of the vehicle at which point current rubber run flat inserts fracture and often times depart the wheel assembly, resulting in sudden changes in vehicle mobility and response. What is needed is a stronger more durable structural material that supports the weight of the vehicle and extends the distance that can be driven on the run-flat insert after the tire flats out.

The current run-flat inserts are also poor thermal conductors, the frictional heating created during run-flat operations is not conducted away from the tire/run-flat insert interface. The heat builds and softens the rubber until the rubber can no longer support the wheel or the combustion temperature of rubber is reached, resulting in a fire. What is needed is a better thermal conductor that minimizes frictional heat build-up by transferring heat from the tire to the wheel and surrounding air.

A lightweight run-flat tire system that allows safe vehicle operation and reliable bead lock during soft soil and flat tire operation is needed to overcome the above-mentioned problems caused by flat tires. The ideal system should be simple to install, should not interfere with low tire inflation pressure operation (i.e., soft soil) and should also provide ballistic impact tolerance and mine blast benefits, and should be adaptable so it can be applied to all wheeled vehicles.

This background section is intended to introduce the reader to various aspects of typical technology that may be related to various aspects or embodiments of the present invention, which are described and/or claimed below. This discussion is believed to be useful in providing the reader with background information to facilitate a better understanding of the various aspects and embodiments of the present invention. Accordingly, it should be understood that these statements are to be read in light of, and not as admissions of, the prior art.

### SUMMARY OF THE INVENTION

It is an object of the present embodiments to provide a system, device and method for a lightweight run-flat tire insert that allows safe vehicle operation and reliable bead lock during low tire inflation pressure operation and flat tire operation.

This and other objects, advantages and features in accordance with the present embodiments may be provided by a run-flat tire insert for use with a wheel having flanges, and a corresponding pneumatic tire having sidewall tire beads with a bead lock edge. The run-flat tire insert includes a deformable annular insert member having a generally u-shaped cross-section with a band portion between opposing leg portions extending radially inward towards the wheel. The deformable annular insert member is made of a fiber-reinforced composite material. The deformable annular insert member is configured as a spring that deflects under load and transmits vertical load forces on the band portion to lateral forces at ends of the opposing leg portions adjacent the bead lock edges of the pneumatic tire against the wheel flanges.

Additionally, and/or alternatively, the spring defines a self-supporting bead lock feature that supports the sidewall tire beads against the wheel flanges during tire deflation and low tire inflation pressure operation.

Additionally, and/or alternatively, the generally u-shaped cross-section is an omega (Ω) shaped cross section, a frustum-shaped cross section, or a chevron-shaped cross section.

Additionally, and/or alternatively, the fiber-reinforced composite material includes a carbon fiber reinforcement in an epoxy resin matrix or a glass fiber reinforcement in an epoxy resin matrix.

Additionally, and/or alternatively, the deformable annular insert member is configured to transfer heat from the pneumatic tire to the wheel and the surrounding air. As such, the thermal conductivity of the fiber-reinforced composite material of the deformable annular insert member may be greater than 0.30 Wm⁻¹K⁻¹.

Additionally, and/or alternatively, a structural foam may fill an interior of the generally u-shaped cross-section of the deformable annular insert member.

Other objects, advantages and features in accordance with the present embodiments may be provided by a run-flat tire insert for use with a wheel having an inboard flange and an outboard flange, and a corresponding pneumatic tire having sidewall tire beads with a bead lock edge. The run-flat tire insert includes a deformable annular insert spring configured to be mounted to the wheel within the tubeless tire. The deformable annular insert spring comprises a fiber-reinforced composite material. The deformable annular insert spring comprises a self-supporting bead lock feature wherein the deformable annular insert spring is configured to deflect under load and transmit vertical load forces thereon to lateral forces adjacent the bead lock edges of the tubeless tire to support the sidewall tire beads against the inboard and outboard flanges during tire deflation and low tire inflation pressure operation.

Additionally, and/or alternatively, the deformable annular insert spring has a generally U-shaped cross section with a band portion between opposing leg portions configured to extend radially inward towards the wheel.

Additionally, and/or alternatively, the fiber-reinforced composite material is a carbon fiber reinforcement in an epoxy resin matrix.

Additionally, and/or alternatively, the deformable annular insert member is configured to transfer heat from the pneumatic tire to the wheel and the surrounding air. As such, the thermal conductivity of the fiber-reinforced composite material of the deformable annular insert member may be greater than 0.30 Wm⁻¹K⁻¹.

Additionally, and/or alternatively, a structural foam may fill an interior of the deformable annular insert member.

Other objects, advantages and features in accordance with the present embodiments may be provided by a method of making a run-flat tire insert for use with a wheel having flanges, and a corresponding pneumatic tire having sidewall tire beads with a bead lock edge. The method includes forming a deformable annular insert member having a generally U-shaped cross-section with a band portion between opposing leg portions configured to extend radially inward towards the wheel. The deformable annular insert member is molded using a fiber-reinforced composite material. The deformable annular insert member is configured as a spring that deflects under load and transmits vertical load forces on the band portion to lateral forces at ends of the opposing leg portions adjacent the bead lock edges of the tubeless tire against the wheel flanges.

Additionally, and/or alternatively, the spring defines a self-supporting bead lock feature that supports the sidewall tire beads against the wheel flanges during tire deflation and low tire inflation pressure operation.

Additionally, and/or alternatively, the generally U-shaped cross-section is an omega (Ω) shaped cross section, a frustum-shaped cross section, or a chevron-shaped cross section.

Additionally, and/or alternatively, the fiber-reinforced composite material comprises a carbon fiber reinforcement in an epoxy resin matrix or a glass fiber reinforcement in an epoxy resin matrix.

Additionally, and/or alternatively, the deformable annular insert member is configured to transfer heat from the pneumatic tire to the wheel and the surrounding air. As such, the thermal conductivity of the fiber-reinforced composite material of the deformable annular insert member is greater than 0.30 Wm⁻¹K⁻¹.

Additionally, and/or alternatively, the method includes filling an interior of the generally U-shaped cross-section of the deformable annular insert member with a structural foam.

### BRIEF DESCRIPTION OF THE DRAWINGS

FIG. 1 is a schematic exploded view illustrating a segmented rubber insert according to a conventional approach.

FIG. 2 is a schematic exploded view illustrating a single donut rubber insert according to a conventional approach.

FIG. 3 is a cross-sectional view of the single donut rubber insert of FIG. 2.

FIG. 4 is a schematic diagram including a cross-sectional view of run-flat tire insert installed on a wheel within a pneumatic tire according to an embodiment of the present invention.

FIG. 5 is a plan view illustrating the run-flat tire insert of FIG. 4 and the transmission of vertical load forces to lateral bead lock forces according to features of the present invention.

FIG. 6A is a perspective sectional view of the run-flat tire insert of FIG. 4 mounted on a wheel.

FIG. 6B is a perspective sectional view of another embodiment of the run-flat tire insert of FIG. 4 mounted on a wheel including a structural foam filling the insert interior.

FIGS. 7A-7C are perspective views of exemplary shapes for the run-flat tire insert of the present invention.

FIG. 8 is a cross-sectional view of a conventional approach using a bead lock device within a pneumatic tire instead of a run-flat insert.

FIG. 9 is a cross-sectional view of the run-flat tire insert of FIG. 4 installed on a wheel within a pneumatic tire and illustrating the bead lock feature according to the present invention.

Some embodiments of the present invention are illustrated as an example and are not limited by the figures of the accompanying drawings, in which like references may indicate similar elements.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An object of the present embodiments may be to provide a lighter weight run-flat tire insert that provides both the run-flat insert and a bead-lock function (some current systems have separate components for insert and bead lock) with improved impact (e.g., ballistic, curbs, potholes) tolerance. The run-flat tire insert will allow the vehicle to maintain mobility for at least twenty-five miles at a speed of thirty mph when one or two tires are flat, and at least five miles at a speed of five mph when three or four are flat on one side.

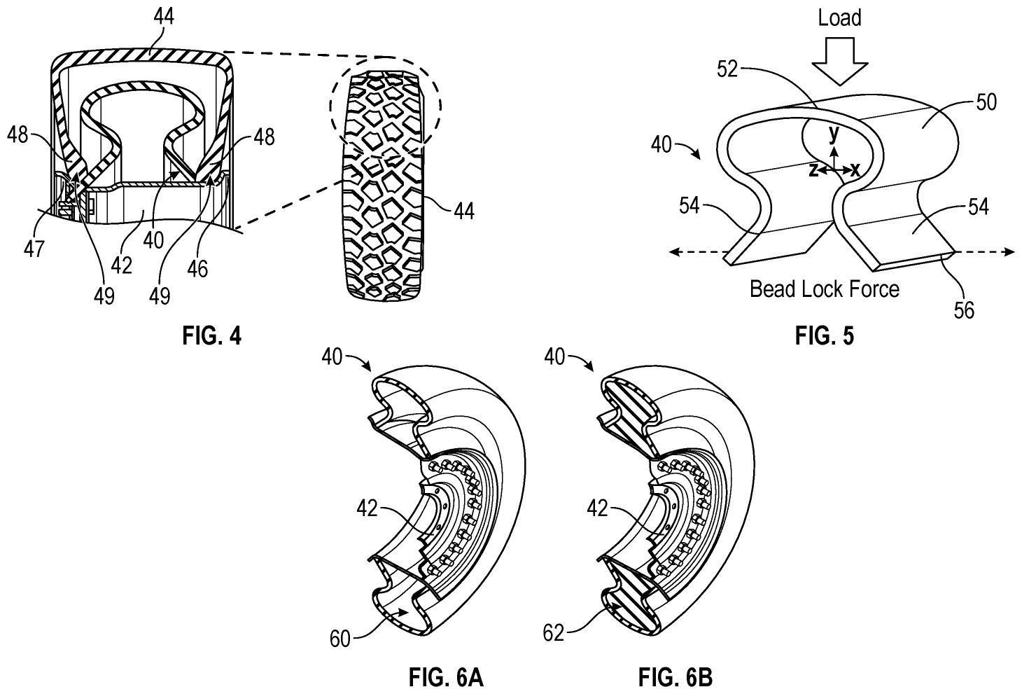

Referring to FIGS. 4, 5, 6A and 6B, an example embodiment including a system, device and method according to features of the present invention is described and illustrated. The example embodiments are best understood from the following detailed description when read with the accompanying drawing figures. Dimensions may be arbitrarily increased or decreased for clarity of discussion.

The run-flat tire insert 40 is for use with a wheel assembly 42 having flanges, for example, an inboard flange 46 (also referred to as an integral flange of the wheel mount) and an outboard flange 47. A corresponding pneumatic tire 44 has sidewall tire beads 48 with a bead lock edge 49. The wheel assembly may be a one-piece or two-piece wheel assembly as would be appreciated by those skilled in the art. An example of a wheel assembly 42 may be Hutchinson WA-2120 as provided by Hutchinson Inc. An example of a pneumatic and/or tubeless tire 44 may be the Michelin XZL series tire which is an all-terrain, all-position radial tire for special service such as Emergency Response, Military and Tactical Wheeled vehicles.

Most tires, such as those for automobiles and bicycles, are pneumatically inflated structures, which also provide a flexible cushion that absorbs shock as the tire rolls over rough features on the surface. Tires provide a footprint, called a contact patch, that is designed to match the weight of the vehicle with the bearing strength of the surface that it rolls over by providing a bearing pressure that will not deform the surface excessively.

The materials of modern pneumatic tires are synthetic rubber, natural rubber, fabric and wire, along with carbon black and other chemical compounds. The fabrics are commonly constructed using high-strength synthetic fibers such as aramid. Steel fibers are also used (e.g., “Steel Belted Radial” tires). They consist of a tread and a body. The tread provides traction while the body provides containment for a quantity of compressed air. Pneumatic tires are used on many types of vehicles, including cars, bicycles, motorcycles, buses, trucks, heavy equipment, and aircraft.

The run-flat tire insert 40 includes a deformable annular insert member 50 having a generally U-shaped cross-section with a band portion 52 between opposing leg portions 54 extending radially inward towards the wheel assembly 42.

The deformable annular insert member 50 is made of a fiber-reinforced composite material. The deformable annular insert member 50 is configured as a spring that deflects under load and transmits vertical load forces on the band portion 52 to lateral forces at ends 56 of the opposing leg portions 54 adjacent the bead lock edges 49 of the pneumatic tire 44 against the wheel flanges 46 and 47.

The deformable annular insert member 50, configured as a spring, may define a self-supporting bead lock feature (e.g., as illustrated in FIGS. 4 and 5) that supports the sidewall tire beads 48 against the wheel flanges 46 and 47 during tire deflation and low tire inflation pressure operation.

FIG. 6A is a perspective sectional view of the run-flat tire insert 40 of FIG. 4 mounted on a wheel 42 including a hollow interior space within the U-shaped cross section. FIG. 6B is a perspective sectional view of another embodiment of the run-flat tire insert 40 of FIG. 4 mounted on a wheel 42 including a structural foam 62 filling the insert interior. The structural foam is formed with a low-pressure form of injection molding (utilizing most thermoplastics or thermosets) to mold a rigid product, which can have thicker walls and higher stiffness-to-weight ratios than a standard injection molded product. In the structural foam process, a physical or chemical blowing agent is mixed in with the resin. The resin is shot into the cavity or interior space of the run-flat tire insert 40, but not completely filled or packed out. The blowing agent expands to push the resin to the extremities of the cavity. As the part cools, the internal pressure of the foaming action takes up the internal shrinkage.

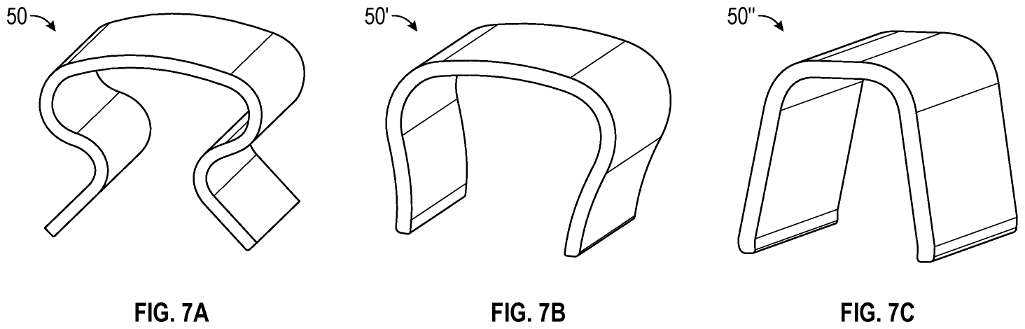

Referring additionally to FIGS. 7A-7C, the generally U-shaped cross-section of the deformable annular insert member 50, 50′ and 50″ may be any substantially arch shape including, for example, an omega (Ω) shaped cross section (FIG. 7A), a bow or arc-shaped cross section (“bread loaf” FIG. 7B), a trapezoid or frustum-shaped cross section (FIG. 7C), or a chevron-shaped cross section (not shown). Other cross-sectional shapes that include a band portion 52 between opposing leg portions 54 extending radially inward towards the wheel assembly 42, and/or that achieve the desired feature of deflecting under load and transmitting vertical load forces on the band portion 52 to lateral forces at ends 56 of the opposing leg portions 54 adjacent the bead lock edges 49 of the pneumatic tire 44 against the wheel flanges 46 and 47, are contemplated.

The deformable annular insert member 50 is preferably configured to transfer heat from the pneumatic tire 44 to the wheel 42, and then to the ambient environment. As such, the thermal conductivity of the fiber-reinforced composite material of the deformable annular insert member 50 may be greater than 0.30 Wm⁻¹K⁻¹, and is preferably in a range between 260-800 Wm⁻¹K⁻¹.

The fiber-reinforced composite material may include a carbon fiber reinforcement in an epoxy resin matrix. Carbon fiber composite is a higher strength material that is a better heat conductor than either rubber or fiberglass, the two materials commonly used for conventional run-flat inserts. In addition to being lighter weight, carbon fiber composites transfer more heat from the tire to the wheel than current inserts, which is another benefit during run-flat operations. Typical thermal conductivity for tire rubber is 0.1730735 Wm⁻¹K⁻¹ (or 0.10-BTU/hr-ft-F°) and for aluminum is 155.7661 Wm⁻¹K⁻¹ (or 90-0.10-BTU/hr-ft-F°), respectively. The thermal conductivity of carbon fibers is as high as 800 Wm⁻¹K⁻¹ (or 462-BTU/hr-ft-F°), providing orders of magnitude better heat transfer than standard tires and steel or aluminum wheels.

Other fiber reinforcements include glass fiber, aramid fiber and para-aramid fiber. DuPont introduced the para-aramid fiber, Kevlar, and it remains one of the best-known para-aramids and/or aramids. A similar fiber called “Twaron” with the same chemical structure was developed by Akzo Nobel N.V. Due to the anisotropic properties of such materials, the fibers may be oriented in preferred directions within the epoxy resin matrix or other resin matrices to further enhance the heat transfer from the tire, via the insert, to the wheel.

Other composites contemplated include: glass fibers and fabrics in polyester and vinyl ester resins; glass fibers and fabrics in phenolic resins; glass fibers and fabrics in thermoplastic resins such as polypropylene, nylon, or Polyether Ether Ketone (PEEK); and carbon and aramid fibers in all the above resins.

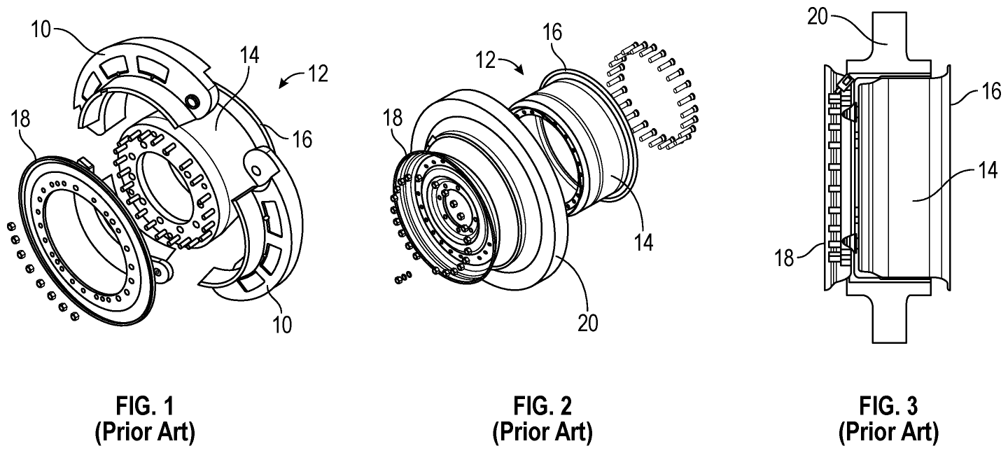

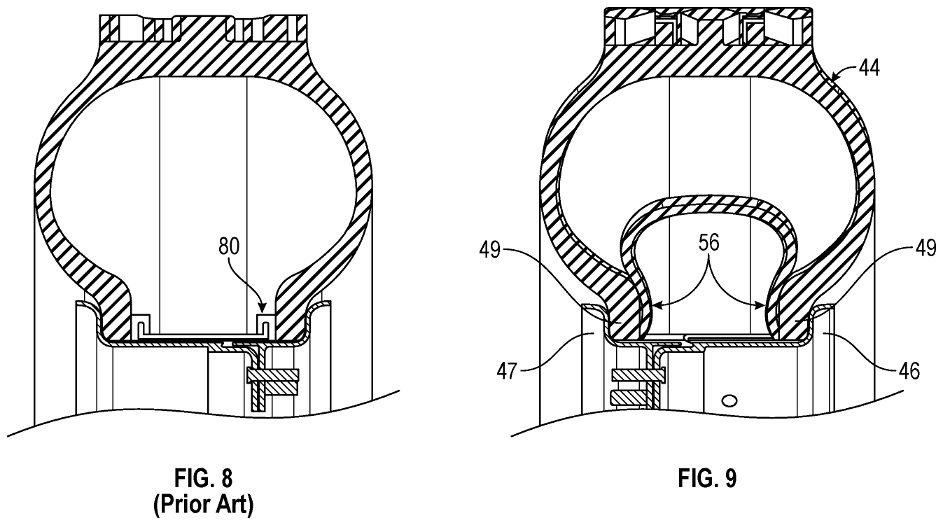

Referring additionally to the comparison illustrated in FIGS. 8 and 9, currently many military vehicles may only use the bead lock device 80 (e.g. FIG. 8) because the current run-flat inserts are too heavy. Alternatively, such a bead lock device 80 may be used in combination with run-flat inserts 10, 20 described above and shown in FIGS. 1-3.

Notably, in the present embodiments, a single part, the run-flat tire insert 50 provides run-flat tire support and bead lock, via the transmission of vertical load forces to lateral forces at ends 56 of the opposing leg portions 54 adjacent the bead lock edges 49 of the pneumatic tire 44 against the wheel flanges 46 and 47 to retain the tire 44 on the wheel 42.

A weight savings of 56 lbs. may be achieved with the use of the run-flat tire insert 40 of the present invention versus the conventional approach.

Accordingly, as described herein, a U-shaped (e.g. omega-shaped, arc-shaped, hat-shaped, trapezoid-shaped, etc.) hollow or filled structural composite insert provides vertical and lateral support. Vertical support holds the weight of the vehicle during flat tire. Lateral support provides bead lock bracing to hold the tire bead in place on the wheel flange and prevent the tire from separating from the wheel during flat tire operation and/or low tire pressure operation. The shape of the run-flat tire insert defines a lightweight spring that transfers the weight of the vehicle to the wheel and elastically deforms in a controlled manner to transfer some of the vehicle load to the tire sidewall to press and support the tire bead against the wheel so the tire does not dismount from the wheel during operation.

As discussed, the present embodiments use advanced composite materials to provide a lightweight composite run flat insert that offers support and resilience during flat tire operation and/or low tire pressure operation. For example, an omega-shaped run-flat tire insert embodiment (cross-sectional shape of the Greek letter Omega (Ω)) may be defined as an arc-shaped leaf spring, and also referred to as the “Omega Run Flat Insert” or ORFI.

The ORFI incorporates a self-supporting bead lock feature that positively secures the tire to the wheel during deflation and low-pressure operation. The hub edges of the insert are compressed against the tire bead when, for example, the wheel halves are bolted together to function better than the typical bead lock system. During total tire deflation when the run-flat tire insert supports the weight of the vehicle, the ORFI transfers vertical load to the bead lock edges to increase bead lock force.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof.

Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims.

Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the invention should be determined by the appended claims and their legal equivalents, and not by the examples given.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

1. A run-flat tire insert for use with a wheel having flanges, and a corresponding pneumatic tire having sidewall tire beads with a bead lock edge, the run-flat tire insert comprising:
a deformable annular insert member having a generally u-shaped cross-section with a band portion between opposing leg portions extending radially inward towards the wheel;
the deformable annular insert member is made of a fiber-reinforced composite material;
the deformable annular insert member is configured as a spring that deflects under load and transmits vertical load forces on the band portion to lateral forces at ends of the opposing leg portions adjacent the bead lock edges of the pneumatic tire against the wheel flanges.

2. The run-flat tire insert according to claim 1, wherein the spring defines a self-supporting bead lock feature that supports the sidewall tire beads against the wheel flanges during tire deflation and low tire inflation pressure operation.

3. The run-flat tire insert according to claim 1, wherein the generally u-shaped cross-section comprises at least one of an omega (Ω) shaped cross section, a frustum-shaped cross section, and a chevron-shaped cross section.

4. The run-flat tire insert according to claim 1, wherein the fiber-reinforced composite material comprises a carbon fiber reinforcement in an epoxy resin matrix.

5. The run-flat tire insert according to claim 1, wherein the fiber-reinforced composite material comprises a glass fiber reinforcement in an epoxy resin matrix.

6. The run-flat tire insert according to claim 1, wherein deformable annular insert member is configured to transfer heat from the pneumatic tire to the wheel.

7. The run-flat tire insert according to claim 6, wherein the thermal conductivity of the fiber-reinforced composite material of the deformable annular insert member is greater than 0.30 Wm⁻¹K⁻¹.

8. The run-flat tire insert according to claim 1, further comprising a structural foam that fills an interior of the generally u-shaped cross-section of the deformable annular insert member.

9. A run-flat tire insert for use with a wheel having an inboard flange and an outboard flange, and a corresponding pneumatic tire having sidewall tire beads with a bead lock edge, the run-flat tire insert comprising:
a deformable annular insert spring configured to be mounted to the wheel within the tubeless tire;
the deformable annular insert spring comprises a fiber-reinforced composite material;
the deformable annular insert spring comprises a self-supporting bead lock feature wherein the deformable annular insert spring is configured to deflect under load and transmit vertical load forces thereon to lateral forces adjacent the bead lock edges of the tubeless tire to support the sidewall tire beads against the inboard and outboard flanges during tire deflation and low tire inflation pressure operation.

10. The run-flat tire insert according to claim 9, wherein the deformable annular insert spring has a generally U-shaped cross section with a band portion between opposing leg portions configured to extend radially inward towards the wheel.

11. The run-flat tire insert according to claim 9, wherein the fiber-reinforced composite material comprises a carbon fiber reinforcement in an epoxy resin matrix.

12. The run-flat tire insert according to claim 9, wherein deformable annular insert member is configured to transfer heat from the pneumatic tire to the wheel.

13. The run-flat tire insert according to claim 12, wherein the thermal conductivity of the fiber-reinforced composite material of the deformable annular insert member is greater than 0.30 Wm⁻¹K⁻¹.

14. The run-flat tire insert according to claim 9, further comprising a structural foam that fills an interior of the deformable annular insert member.

15. A method of making a run-flat tire insert for use with a wheel having flanges, and a corresponding pneumatic tire having sidewall tire beads with a bead lock edge, the method comprising:
forming a deformable annular insert member having a generally U-shaped cross-section with a band portion between opposing leg portions configured to extend radially inward towards the wheel;
the deformable annular insert member is molded using a fiber-reinforced composite material;
the deformable annular insert member is configured as a spring that deflects under load and transmits vertical load forces on the band portion to lateral forces at ends of the opposing leg portions adjacent the bead lock edges of the tubeless tire against the wheel flanges.

16. The method according to claim 15, wherein the spring defines a self-supporting bead lock feature that supports the sidewall tire beads against the wheel flanges during tire deflation and low tire inflation pressure operation.

17. The method according to claim 15, wherein the generally U-shaped cross-section comprises at least one of an omega (Ω) shaped cross section, a frustum-shaped cross section, and a chevron-shaped cross section.

18. The method according to claim 15, wherein the fiber-reinforced composite material comprises at least one of a carbon fiber reinforcement in an epoxy resin matrix and a glass fiber reinforcement in an epoxy resin matrix.

19. The method according to claim 15, wherein deformable annular insert member is configured to transfer heat from the pneumatic tire to the wheel; and wherein the thermal conductivity of the fiber-reinforced composite material of the deformable annular insert member is greater than 0.30 Wm⁻¹K⁻¹.

20. The method according to claim 15, further comprising filling an interior of the generally U-shaped cross-section of the deformable annular insert member with a structural foam.
